(19) United States
(12) Patent Application Publication
(10) Pub. No.: US 2018/0205536 A1
(43) Pub. Date: Jul. 19, 2018

(54) STREAM CIPHER SYSTEM

(71) Applicant: PQ Solutions Limited, London (GB)

(72) Inventor: Martin Tomlinson, Totnes (GB)

(21) Appl. No.: 15/711,361

(22) Filed: Sep. 21, 2017

(30) Foreign Application Priority Data
Jan. 14, 2017 (GB) 1700670.1

(51) Int. Cl. H04L 9/06; H04L 9/08

(52) U.S. Cl. CPC H04L 9/0631; H04L 9/0643; H04L 9/0869

(57) ABSTRACT

A cipher encryption system and method, where the ciphertext that is produced has two parts, the first part being the result of encrypting a function output of the message by using a block or stream cipher. The message function may be a cryptographic hash of the message. The second part is produced by adding the keystream output of a cryptographic random number generator to the message stream. The seed of the random number generator is determined by combining the encryption key with the hash of the message. Decryption is the reverse process; the message hash is determined by decrypting the first part of the ciphertext and an identical keystream is produced by seeding a cryptographic random number generator with a combination of the encryption key and the decrypted message hash. A method and system are described which produces a keystream with higher entropy than the message, by periodically reseeding the random number generator from hashes of permuted subsets of the message stream that have already been encrypted.

This patent application claims priority to GB Application 1700670.1, entitled “Improved Stream Cipher System”, filed on Jan. 14, 2017.

### FIELD OF THE INVENTION

This invention relates to data processing, and more particularly to systems and methods for symmetric key stream cipher based cryptosystems.

### BACKGROUND TO THE INVENTION

Stream cipher systems have been around since 1882 when Frank Miller invented an encryption method for use in telegraph transmission. In atypical stream cipher system, for example as schematically illustrated in FIG. 1, each cipher digit of a pseudorandom keystream is combined with a corresponding digit of a plaintext data message to form the ciphertext stream, using character by character modulo addition or more commonly bit by bit modulo 2 addition. The keystream is generated using a pseudorandom number generator from an input seed value that serves as the cryptographic key for decrypting the ciphertext stream. The plaintext is recovered by a recipient of the ciphertext by adding, modulo 2, a locally generated version of the keystream to the ciphertext stream. The famous scientist Claude Shannon proved in 1949 that if the keystream is a one-time pad of randomly chosen bits then perfect secrecy is obtained. For secure teleprinter communications from the 1920's until the 1960's, stream ciphers using large numbers of rolls of one-time paper tapes were very popular with the military and governments. In 1955 the US government consumed almost 2 million, one-time paper tape rolls, all of which had to be securely manufactured, transported, guarded and destroyed after use.

As indicated by the name, a one-time pad can only be used once. If it is ever used more than once, then there is no security because adding together the two ciphertexts that were produced cancels out the common keystream. The result is the modulo 2 sum of the two plaintext messages. Modern stream cipher systems such as ChaCha20, AES in counter mode and Keyak generate a pseudo random keystream using an encryption key as input. To ensure that each message is encrypted with a different keystream, a message counter value, or a random nonce, is appended to the key. Of course the recipient of the ciphertext needs to know the counter or nonce value otherwise the ciphertext cannot be decrypted. Protocols have been developed to achieve this but to ensure that a random nonce value, or a counter value is never used again, is difficult in practice.

What is desired is an improved stream cipher system that greatly reduces the probability of a repeated keystream and that does not rely on counter values or random nonces as typically implemented in known systems.

### STATEMENTS OF THE INVENTION

Aspects of the present invention are set out in the accompanying claims. According to one aspect, the present invention provides a method of encryption of a message in which a ciphertext is generated by: producing a function of part or all of the message and encrypting the function output to form a first part of the ciphertext, combining the function output with a key and using the combined result to seed a random number generator; adding, modulo an integer p, the output of the random number generator to the message in the form of a message stream to produce a second part of the ciphertext.

According to another aspect, the present invention provides a method of decrypting a ciphertext in which a first part of the ciphertext is decrypted to produce a function output of part or all of the message; combining the function output with a key and using the combined result to seed a random number generator; subtracting, modulo an integer p, the output of the random number generator from the second part of the ciphertext to reproduce the message.

The function output may be the result of hashing the message.

The message function output may be encrypted with a stream cipher.

The message function output may be encrypted with a block cipher.

Decryption may include determining the message function output by decrypting the first part of a cipher.

Correct decryption may be indicated by equality of the decrypted function output of part or all of the message with a calculated function output of part or all of the decrypted message.

The seed of a random number generator may be the result of combining a key with a hash of the message added to a hash of a sub-set of the message.

The seed of the random number generator may be the result of combining the key with a hash of the message added to a hash of a permutation of a sub-set of the message, said permutation being a function of a previous value formed from the hash summation.

The seed of a random number generator may be the result of combining a key with the decrypted hash of the message added to a hash of a sub-set of the decrypted message thus far.

The seed of a random number generator may be the result of combining a key with the decrypted hash of the message added to a hash of a permutation of a sub-set of the decrypted message thus far, said permutation being a function of a previous value formed from the hash summation.

According to another aspect, the present invention provides an encryption method of generating ciphertext from a message consisting of a stream of data values, the method comprising applying a function to part or all of the message data to generate a function output; encrypting the function output to form a first part of the ciphertext; generating a seed value based on the function output and a key; using the generated seed value to seed a random number generator that outputs a stream of random numbers; and adding, modulo an integer p, the output stream of the random number generator to the message data stream to produce a second part of the ciphertext.

According to another aspect, the present invention provides method of decrypting a ciphertext constructed according to above encryption method, comprising: decrypting a first part of the ciphertext to reproduce the function output of part or all of the message; generating a seed value based on the reproduced function output and a key; using the generated seed value to seed a random number generator that outputs a stream of random numbers; and subtracting, modulo an integer p, the output stream of the random number generator from the second part of the ciphertext to reproduce the message.

According to another aspect, the present invention provides a method of generating a keystream for cipher stream encryption of plaintext data, wherein the keystream is derived by a random number generator using a seed value computed from said plaintext.

In other aspects, there is provided a system configured to perform the methods as described above. The system may comprise software to simulate a device configured to perform the methods outlined above so as to produce the same numerical outputs as the corresponding hardware.

The system may comprise hardware or software or a combination of hardware and software that implements any of the methods outlined above.

### BRIEF DESCRIPTION OF THE DRAWINGS

There now follows, by way of example only, a detailed description of embodiments of the present invention, with references to the figures identified below.

FIG. 1 is a schematic block diagram illustrating a typical stream cipher encryption system as is known in the art.

FIG. 2 is a schematic block diagram showing functional and data components of a stream cipher encryption system according to an embodiment of the invention.

FIG. 3 is a block diagram showing an exemplary data structure of the ciphertext composed of two parts Cₐ and C_{b} output by the system of FIG. 2.

FIG. 4 is a schematic block diagram showing components of a stream cipher decryption system according to an exemplary embodiment of the invention.

FIG. 5 is a schematic block diagram of a stream cipher encryption system according to another exemplary embodiment, in which the key is appended with a salt and at least a portion of the second ciphertext part C_{b}.

FIG. 6 is a schematic block diagram of an encryption system according to a further embodiment in which the first ciphertext part Cₐ is produced using a block cipher.

FIG. 7 is a schematic block diagram of the complementary decryption system to the encryption system of FIG. 6, according to a further embodiment.

FIG. 8 is a schematic block diagram showing a decryption system configured to prevent an adaptive chosen ciphertext attack according to a further embodiment.

FIG. 9 is a schematic block diagram showing components of the encryption system of FIG. 10, in which a message is divided into subsets that are hashed.

FIG. 10 is a schematic block diagram of an encryption system configured to process long messages according to another embodiment, in which subsets of the message are hashed and used as input to a data transformer whose output determines the seed of the random number generator.

FIG. 11 is a schematic block diagram showing a further alternative arrangement in which a message is divided into subsets which are permuted under control of a hash value before being hashed.

FIG. 12 is a schematic block diagram of a decryption system configured to process long messages according to another embodiment.

FIG. 13 is a block diagram of a computer system on which one or more of the functions of the embodiments may be implemented.

### DETAILED DESCRIPTION OF EMBODIMENTS OF THE INVENTION

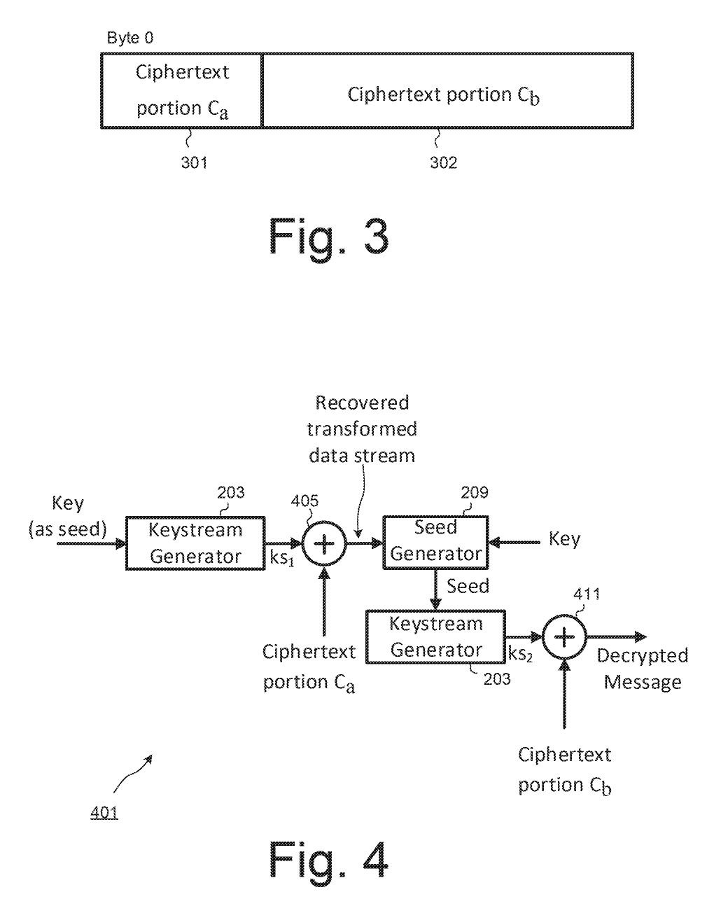

A first embodiment of the invention will now be described with reference to the exemplary stream cipher system 201 shown in FIG. 2, which may form part of a secured computing or hardware environment. In this exemplary embodiment, the stream cipher system 201 receives an input data message and a symmetric key, and generates an output ciphertext comprising two ciphertext portions Cₐ and C_{b}. FIG. 3 schematically illustrates an exemplary data structure of the complete ciphertext with the first ciphertext portion Cₐ 301 followed by the second ciphertext portion C_{b} 302.

The stream cipher system 201 includes a keystream generator 203 that pseudorandomly generates a first keystream ks₁ from a received first seed value. In this exemplary embodiment, the first seed value consists of the key. The keystream generator 203 may be a pseudorandom number generator of a type that is known per se, such as a block cipher in counter mode, elliptic curve generator, non-linear feedback shift register, or the like, that outputs a data stream of random numbers from the input seed value as the first keystream ks₁. Alternatively, the keystream generator 203 may be configured to generate the keystream from the first seed value using an extendable hash function or sponge function such as the Keccak algorithm. A first adder 205 of the stream cipher system 201 generates the first ciphertext portion Cₐ 301 by adding modulo p, where p is a predefined integer value, the keystream ks₁ produced by the keystream generator 203 to a data stream output by a data transformer 207.

The data transformer 207 is configured to generate transformed data as an output data stream based on received plaintext message data, by applying a defined function that transforms the plaintext message data. For example, the defined function may be a mapping function of a type that is generally known per se, such as a hash function, an extendable hash function or sponge function such as the Keccak algorithm, matrix multiplication, exponentiation modulo a prime, elliptic curve point multiplication, or the like, that maps the plaintext message data of arbitrary size to output data of fixed size. For even greater implementation efficiency, the same extendable hash function may be used by the data transformer 207 to produce the message hash as well as by the keystream generator 203 to generate the keystreams. As another example, the data transformer 207 may implement a look up table that defines replacement output data values for each data value in the plaintext message.

As yet another example, the defined function may instead be a rudimentary function such as data truncation to simply pass through part of the message of a calculated length, or a mathematical function that determines particular digits or parts of the message data to be selected as output data. Such a relatively simple data transformation function is particularly advantageous for lightweight cryptosystems for use in low cost applications, such as Internet of Things applications.

The adder 205 may be configured to perform bit-wise addition of the input data streams, in which case the integer p may be equal to 2. Alternatively, the adder 205 may be configured to perform byte-wise addition of the input data streams, in which case p may be equal to 256. It is evident that the adder 205 may be configured to perform addition modulo other suitable integer values of p.

The transformed data output by the data transformer 207 is also passed to a seed generator 209 that generates a second seed value based on the received transformed data stream and the key. The seed generator 209 may be configured to compute the second seed value by combining the received data elements for example by concatenation, addition, multiplication, hashing, or the like. The output of the seed generator 209 is passed to the keystream generator 203 which produces a second keystream ks₂ from the received second seed value. A second adder 211 of the stream cipher system 201 generates the second ciphertext portion C_{b} by adding modulo p, the second keystream ks₂ to the plaintext message. The complete ciphertext formed from the first and second ciphertext portions 301 and 302 may then be transmitted to a recipient for decryption.

Advantageously, embodiments of the present invention provide a stream cipher system adapted to generate a keystream that is dependent on the plaintext message itself, so that if a second plaintext message is different from a first message then the keystream that is generated will be different from the first keystream. Accordingly this stream cipher system will approximate to a one-time pad, stream cipher system.

Of course the recipient of the ciphertext C_{b} does not know the message beforehand and so cannot produce the message function output necessary to produce the correct keystream to decrypt C_{b}. This is where ciphertext Cₐ comes into use. As the recipient knows the key used to encrypt Cₐ the recipient is able to decrypt Cₐ, reproducing the message function output and in turn to produce the correct keystream to decrypt the message ciphertext C_{b}.

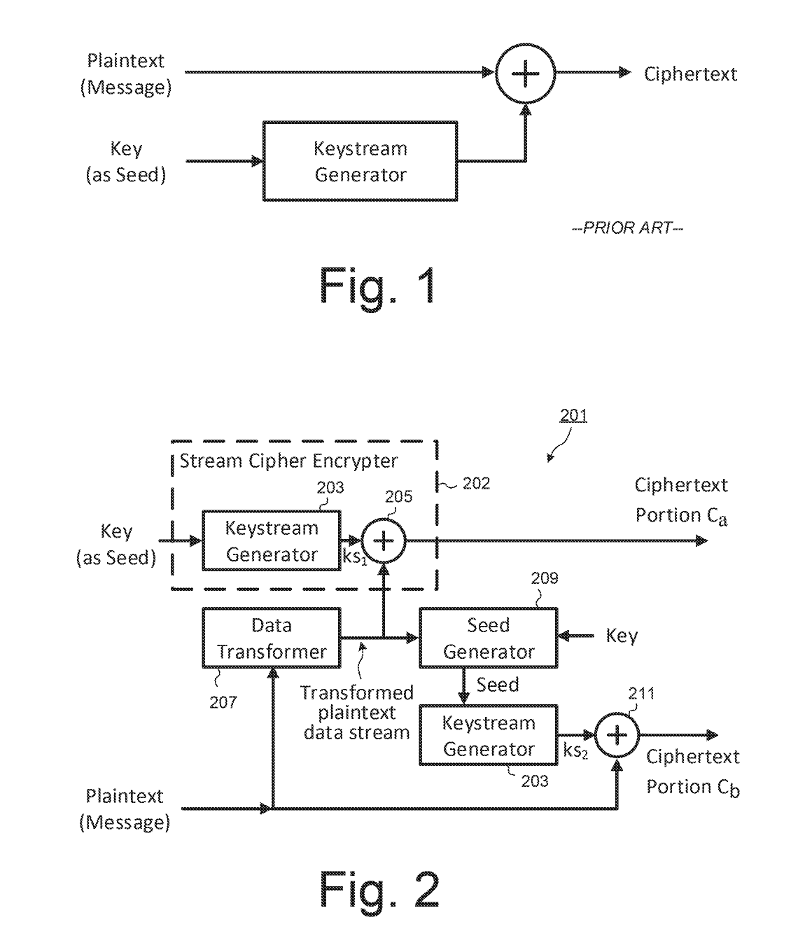

A worked example will now be given, with reference to the components of the stream cipher encryption system 301 shown in FIG. 1, where the plaintext mapper 207 implements a hash function to derive a mapped output data stream of a fixed length. Using a computed hash of the complete message as the mapping function provides further cryptographic advantages as discussed below. In this worked example, the particular hash function used is the SHA-3 cryptographic hash function, a standard published by the United States of America's, National Institute of Standards and Technology, NIST. SHA3-256 is used having a 256 bit (32 bytes) output.

The example plaintext message is the classic message:

“The quick brown fox jumps over the lazy dog”.

This example plaintext message represented as an American Standard Code for Information Interchange (ASCII) byte stream is:

84 104 101 32 113 117 105 99 107 32 98 114 111 119 110 32 102
111 120 32 106 117 109 112 115 32 111 118 101 114 32 116 104
101 32 108 97 122 121 32 100 111 103

The example cryptography key is a character string, a password concatenated with a salt: Aer0.plaNe.<71349and48702lgeinydtejw267716o

The SHA3-256 bit hash of the plaintext message output by the mapper 207 is the following data stream of 32 byte values:

1 222 221 93 228 239 20 100 36 69 186 95 91 151 193 94 71 185
173 147 19 38 228 176 114 124 217 76 239 196 79

Using the keystream generator 203 with the above key as the seed value produces the following 32 byte first keystream ks₁:

70 76 56 157 215 49 144 141 83 153 1 107 147 132 212 155 110
219 219 72 162 17 107 140 48 210 126 208 80 252 13

When this first keystream ks₁ is added modulo 2, by the first adder 205, to the message hash output by the mapper 207, the following 32 byte ciphertext portion Cₐ is produced:

71 146 229 192 51 222 132 233 119 220 187 52 200 19 21 197 41
98 118 219 177 55 143 60 66 174 167 156 191 56 66

The seed generator 209 generates a second seed value by combining the encryption key with the 32 byte data stream output by the data transformer 207. In this worked example, the second seed value is generated by concatenating the encryption key with the message hash output by the data transformer 207. The output from the seed generator 209 is provided as a seed value to the keystream generator, which produces the following second keystream ks₂:

78 204 155 250 213 42 59 179 236 157 51 108 53 185 152 62 79
15 242 67 36 62 226 214 183 206 66 5 75 31 238 83 96 4 114 73
184 82 195 216 53 110 66

This second keystream, ks₂. is added modulo 2, by the second adder 211, to the plaintext message byte stream to produce the second ciphertext portion C_{b} as the following 43 byte sequence:

26 164 254 218 164 95 82 208 135 189 81 30 90 206 246 30 41
96 138 99 78 75 143 166 196 238 45 115 46 109 206 39 8 97 82
37 217 40 186 248 81 1 37

The resulting complete ciphertext comprising the first ciphertext portion Cₐ and the second ciphertext portion C_{b} is the following 75 byte sequence:

71 146 229 192 51 222 132 233 119 220 187 52 200 19 21 197
41 98 118 219 177 55 143 60 66 174 167 156 191 56 66 26 164
254 218 164 95 82 208 135 189 81 30 90 206 246 30 41 96 138
99 78 75 143 166 196 238 45 115 46 109 206 39 8 97 82 37 217
40 186 248 81 1 37

A further worked example will now be discussed to illustrate the effect of a small change (highlighted by the underline) to the example plaintext message:

“The quick brown fox jumps over the lazy cat”.

The SHA3-256 bit message hash output by the data transformer 207 now becomes:

88 225 223 158 148 19 206 27 120 231 216 246 110 114 73 45
221 112 231 22 250 203 197 131 159 81 118 102 161 246 139

It will be appreciated that the example message hash of this subsequent worked example is substantially different from the previous example message hash. Consequently, in this subsequent worked example, the second seed value output by the seed generator 209 to the keystream generator 203 is also different, resulting in the following second keystream ks₂:

245 168 163 96 194 39 106 55 53 98 158 53 166 197 183 39 166
24 37 131 21 214 58 181 187 138 36 241 152 151 115 154 206
124 117 9 236 253 224 204 67 189 76

Every byte of this 43 byte second keystream ks₂ is different from the corresponding 43 bytes of the second keystream ks₂ generated in the first worked example, even though the same cryptography key is used. This example shows that the classic vulnerability of stream ciphers is solved by the described embodiment. The only way that the same keystream is produced following a change to the plaintext message is if the message hash output by the data transformer 207 remains unchanged. This can only happen if the SHA-3 hash function has a collision and produces the same output for two different inputs. The SHA-3 hash function has been designed to be second pre-image resistant and for a 256 bit hash value, the probability of any two messages having the same hash value is less than 2-128.

FIG. 4 is a schematic block diagram of the complementary stream cipher decryption system 401 according to an exemplary embodiment of the invention, using corresponding reference numerals to those of preceding figures where appropriate for corresponding elements. The stream cipher decryption system 401 is used by the recipient to decrypt the received complete ciphertext as output by the encryption system 201 of FIG. 2. Following from the first worked example set out above, the recipient knows the symmetric key:

Aer0.plaNe.<71349and48702lgeinydtejw267716o

Using this key as the seed value for the keystream generator 203 produces the same first keystream ks₁ as used by the encryption system 201 to compute the first ciphertext portion Cₐ, namely the 32 byte keystream ks₁:

70 76 56 157 215 49 144 141 83 153 1 107 147 132 212 155 110
219 219 72 162 17 107 140 48 210 126 208 80 252 13

The decryption system 401 parses the received ciphertext to identify the first ciphertext portion Cₐ 301 and the second ciphertext portion C_{b} 302, the first portion having a known length. As shown in FIG. 4, the first keystream ks₁ is added, modulo 2, by the first adder 405 to the received first ciphertext portion Cₐ, to reproduce the message hash:

1 222 221 93 228 239 20 100 36 69 186 95 91 151 193 94 71 185
173 147 19 38 228 176 114 124 217 76 239 196 79

It should be noted that if modulo p addition has been used for encryption then modulo p subtraction should be used for decryption. In the special case of p equal to 2, addition modulo 2 by an adder is the same as subtraction modulo 2.

To produce the same second seed value as used by the encryption system 201, the recovered message hash (the transformed data stream as output by the data transformer 207 of the encryption system 201) is input to the seed generator 209 of the decryption system 401, along with the key. In this example, the seed generator 209 concatenates the recovered transformed message data with the key to form the second seed value that is passed to the keystream generator 203 to reproduce the same second keystream ks₂ as used by the encryption system 201 to compute the second ciphertext portion C_{b}, namely the stream of 43 bytes:

78 204 155 250 213 42 59 179 236 157 51 108 53 185 152 62 79
15 242 67 36 62 226 214 183 206 66 5 75 31 238 83 96 4 114 73
184 82 195 216 53 110 66

As shown in FIG. 4 this second keystream ks₂ is added, modulo 2, by the second adder 411 of the decryption system 401 to the received second ciphertext portion C_{b} to reproduce the following stream of 43 bytes:

84 104 101 32 113 117 105 99 107 32 98 114 111 119 110 32 102
111 120 32 106 117 109 112 115 32 111 118 101 114 32 116 104
101 32 108 97 122 121 32 100 111 103

This is the ASCII byte stream representation of the original plaintext message:

“The quick brown fox jumps over the lazy dog”.

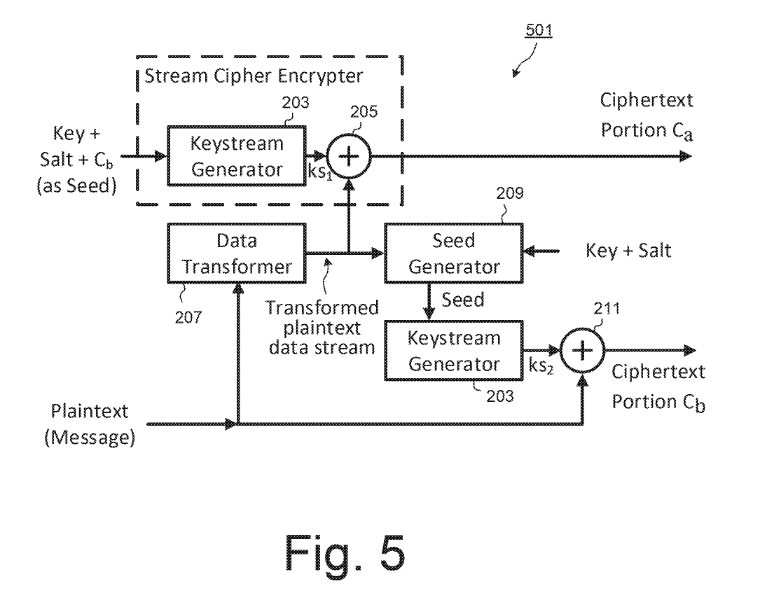

FIG. 5 is a schematic block diagram of a stream cipher encryption system 501 according to another embodiment, using corresponding reference numerals to those of preceding figures where appropriate for corresponding elements. As shown in FIG. 5, the first seed value in this embodiment consists of the key, and a salt and some or all of the bits of ciphertext portion C_{b} as output by the adder 211, appended to the key. This embodiment further advantageously provides enhanced security in the encipherment of the transformed data by increasing the entropy of the seed of the key stream generator 203.

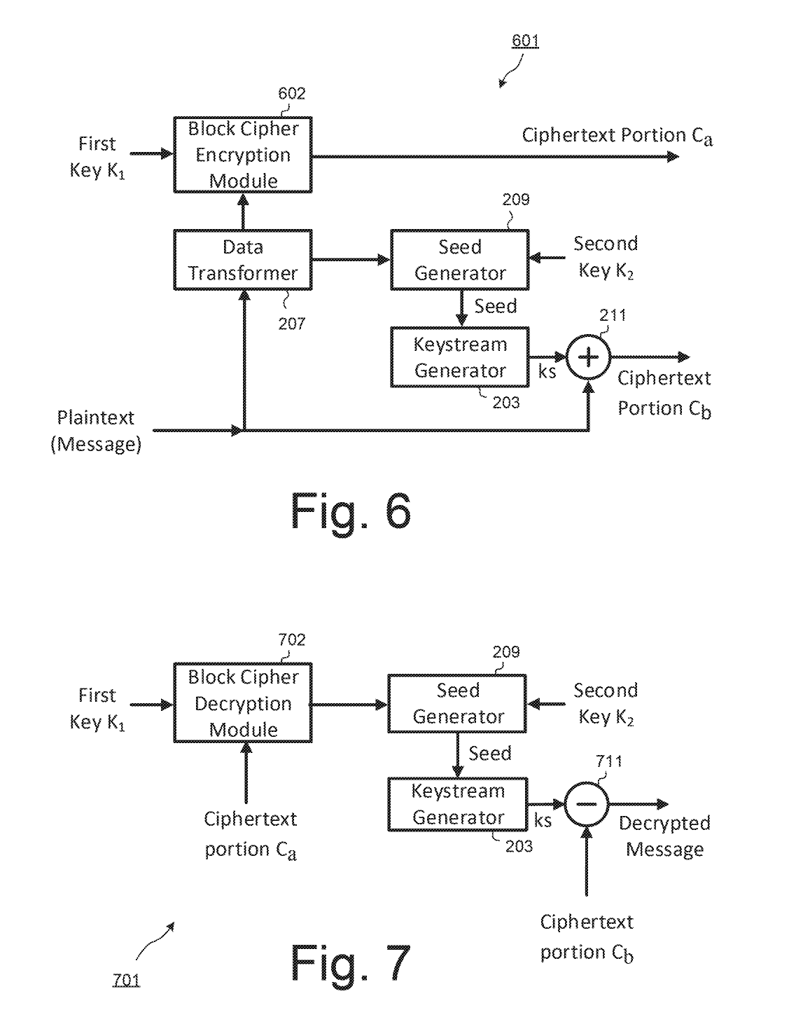

FIG. 6 is a schematic block diagram of an encryption system 601 according to another embodiment, using corresponding reference numerals to those of preceding figures where appropriate for corresponding elements. As shown in FIG. 6, the transformed message data output by the data transformer 207 is encrypted using a block cipher encryption module 602 with a first cryptography key K₁ to produce the first ciphertext portion Cₐ. The block cipher encryption module 602 may implement a block cipher algorithm of a type that is known per se, such as the Advanced Encryption Standard (AES), the Speck algorithm by the National Security Agency (NSA), Blowfish, or the like. The transformed message data is also passed to a seed generator 209 that generates a second seed value based on the received transformed data stream and a second key K₂. The output of the seed generator 209 is passed to a keystream generator 203 to produce a keystream ks. An adder 211 of the encryption system 601 generates the second ciphertext portion C_{b} by adding, modulo p, the keystream ks to the plaintext message. It is not essential that the two keys K₁ and K₂ are different. A common key could instead be used.

The complementary decryption system 701 is shown in FIG. 7, using corresponding reference numerals to those of preceding figures where appropriate for corresponding elements. In this further embodiment, the received first ciphertext portion Cₐ is decrypted using a block cipher decryption module 702 with the first key K₁. The output is the recovered transformed message data as output by the data transformer 207 of the encryption system 601, which is input to a seed generator 209 of the decryption system 701, along with the second key K₂. The seed generator 209 combines the recovered transformed message data with the second key K₂ to produce the seed value that is passed to the keystream generator 203 to reproduce the same keystream ks as used by the encryption system 601 to compute the second ciphertext portion C_{b}. The recovered keystream ks is subtracted modulo p, by subtractor 711, from the received second ciphertext portion C_{b} to reproduce the plaintext message.

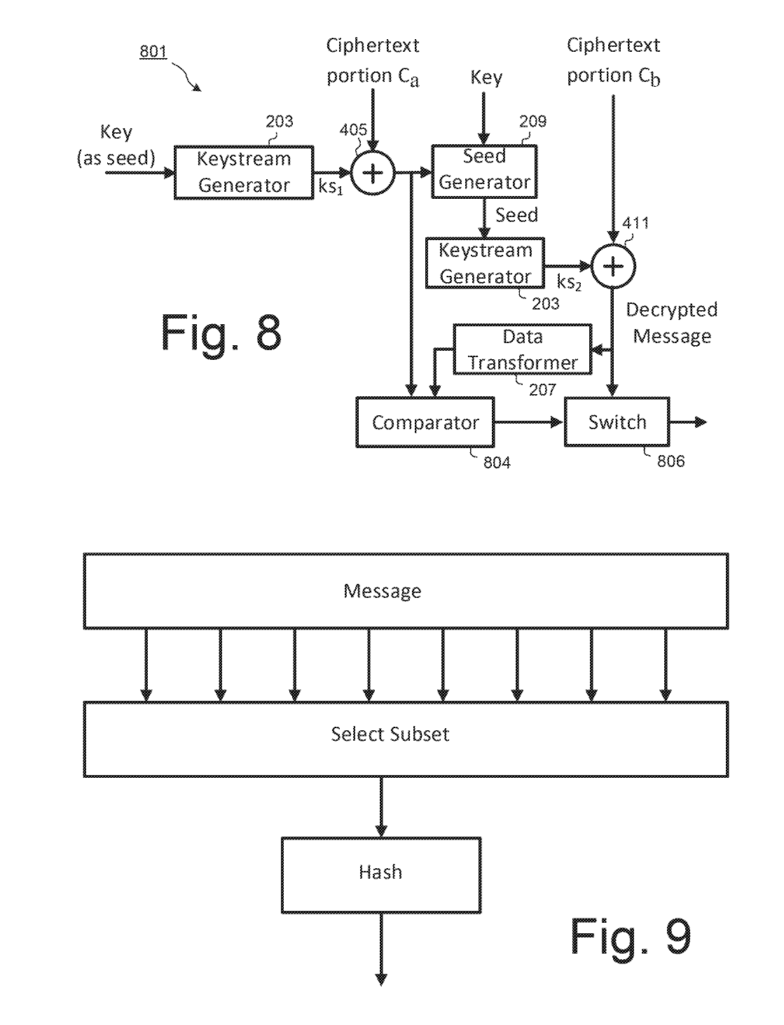

FIG. 8 is a schematic block diagram showing components of a decryption system according to a further embodiment, using corresponding reference numerals to those of preceding figures where appropriate for corresponding elements. From a security point of view, stream ciphers are typically susceptible to chosen ciphertext attacks (CCAs), where an attacker can flip a bit of the ciphertext and with a decryption oracle, observe the message corrupted by just one bit in the flipped bit position. As shown in FIG. 8, the decryption system 801 of this embodiment is configured to prevent an adaptive chosen ciphertext attack, by utilising the recovered transformed data (e.g. message hash) that becomes available following the decryption of Cₐ, thereby enabling the realisation of a CCA immune decryption system. As described in the embodiment above with reference to FIG. 4, the decryption of Cₐ reproduces the transformed message data as output by the data transformer 207 of the complementary encryption system 201. The reproduced transformed message data is provided as input to a comparator 804 of the decryption system 801 in this embodiment. The decryption of C_{b} reproduces the plaintext message which is provided as input to a data transformer 207 of the decryption system 801 in this embodiment, as shown in FIG. 8. The output of the data transformer 207 is also provided as input to the comparator 804, which determines if the two inputs are identical. Only if the two inputs to the comparator 804 are identical does a switch 806 operate to output the decrypted message, otherwise a NULL or error may be output.

If the attacker makes any changes to the ciphertext parts of Cₐ or C_{b} or both parts then the transformed data output by the data transformer 207 following decryption of C_{b} will not match the output (the reproduced transformed data) produced by the decryption of Cₐ. The chance of a match is the same as the chance of a hash collision which is insignificant for a cryptographic hash function like SHA-3. FIG. 10 is a schematic block diagram showing components of a stream cipher encryption system according to another embodiment, using corresponding reference numerals to those of preceding figures where appropriate for corresponding elements. For long messages the entropy of the message exceeds the entropy of the key. As the cryptographic key generator is deterministic, given the seed, the entropy of the keystream cannot exceed that of the seed. Consequently the message entropy will exceed that of the keystream and for the stream cipher the approximation to the one-time pad will break down. In this embodiment different message hashes from selected subsets of the message are calculated as shown in the block schematic diagram of FIG. 9 to provide more entropy to the seed of the keystream generator.

As shown in FIG. 10, this embodiment is adapted to calculate different message hashes from selected subsets of the message. In this embodiment, the seed generator 209 receives as inputs the key and a data stream output by an adder 1010, which is a bit by bit, modulo 2 sum, of the hash of the whole message (as output by data transformer 207a implementing a hash function) and the hash of a subset of the message (as output by data transformer 207b implementing a hash function). A subset selector 1012 is configured to ensure that each message subset is correctly chosen, by choosing each subset from the parts of the message that have already been enciphered. This is to ensure that these message subsets will be available to the recipient following decryption by the recipient up to that point where the second seed value (as output by the seed generator 209) changes. Initially, the subset is zero and the data stream input to the seed generator 209 is the hash of the whole message, Hₘ and the bit by bit, modulo 2 sum of the hash of zero, H₀. The keystream generator 203 is seeded from the output of the seed generator 209. After encipherment of t bits the message subset is some or all of these t bits, not necessarily in consecutive order, and these are hashed by the data transformer 207b to produce the hash H₁. The seed generator 209 now has one data stream input that is the sum of Hₘ and H₁, as output by adder 1010. The keystream generator 203 is provided with the new seed value as output by the seed generator 209, to generate an updated second key stream ks₂.

After encipherment of a further t bits, the message subset now becomes some or all of the previously enciphered 2t bits, again not necessarily in consecutive order, and these are hashed to produce the hash Hz. The seed generator 209 now has one data stream input that is the sum of Hₘ and Hz, as output by adder 1010. The keystream generator 203 is again updated with the new seed value as output by the seed generator 209. The procedure repeats with a new seed value produced, and a corresponding new, independent second keystream ks₂ produced after encipherment of every t bits. In this way, with appropriate choice of the parameter t the entropy of the keystream can be made to exceed the entropy of the message. Thus the stream cipher will approximate to a stream cipher using a one-time pad.

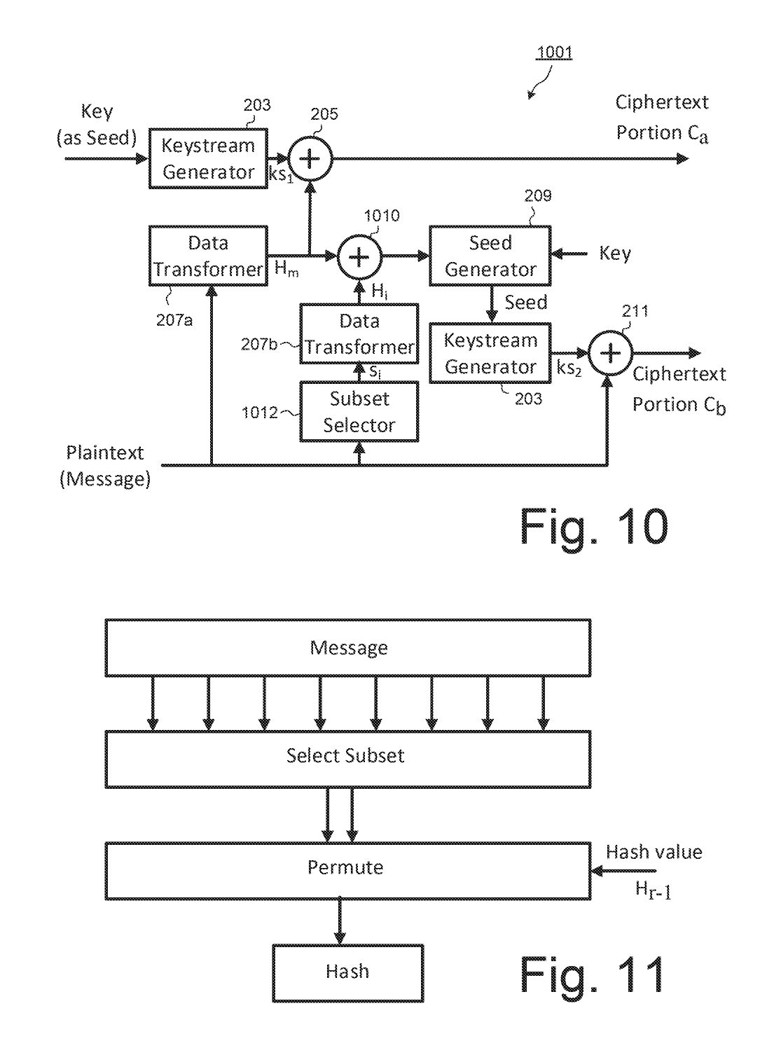

As a further possible refinement, in case there are sets of very similar messages to be enciphered, the subset of rt message bits, after encipherment of rt bits may be permuted in an order determined by the previous hash value Hᵣ₋₁. The alternative arrangement is shown in FIG. 11.

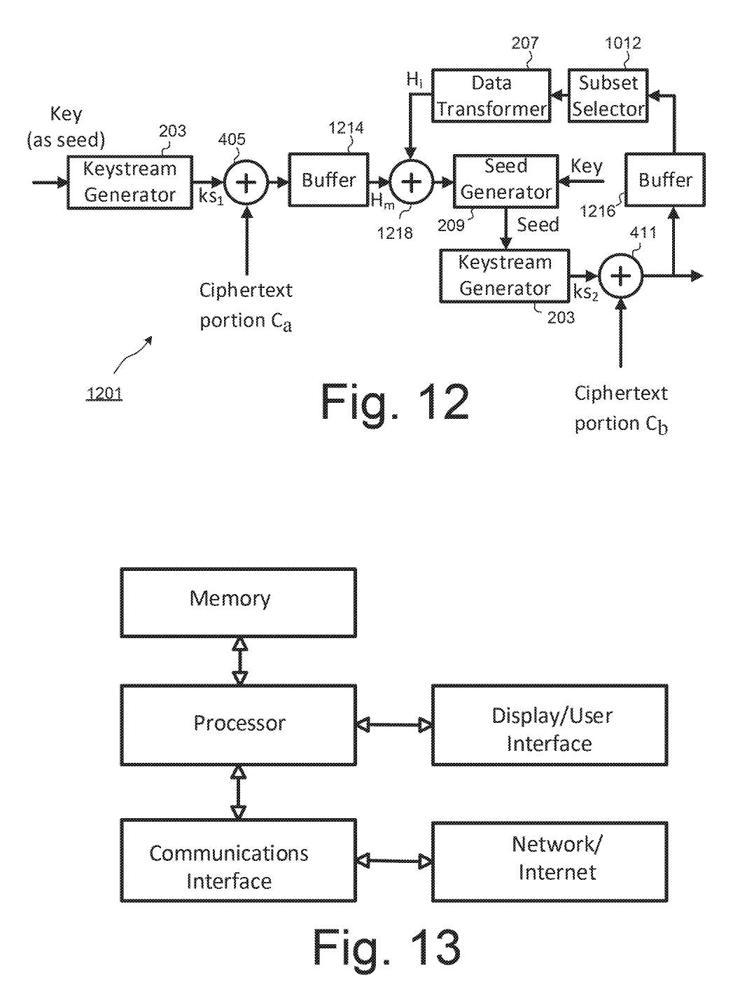

The complementary decryption system is shown in FIG. 12, using corresponding reference numerals to those of preceding figures where appropriate for corresponding elements. In this further embodiment, following decryption of Cₐ which reproduces the message hash, this output from adder 405 is stored in a first buffer 1214. The decrypted message, as it is produced bit by bit and output by adder 411, is stored in a second buffer 1216. A subset of memory locations of this second buffer 1216 corresponding to the bits of ciphertext C_{b} decrypted so far are selected by subset selector 1012 and provided as inputs to a data transformer 207, implementing a hash function in this embodiment. The same message subset selector 1012, as used in the complementary encryption system 1001, is used for decryption. If the additional permutation function shown in the alternative arrangement of FIG. 11 was used in the encryption system 1001, the same arrangement is also employed in the decryption system 1201 of this embodiment.

Initially, before any bits have been decrypted from ciphertext C_{b}, the message subset is equal to zero and the input to the seed generator 209 is the result of decrypting the ciphertext Cₐ, the hash of the whole message, Hₘ and the bit by bit, modulo 2 sum of the hash of zero, H₀. The other input to the seed generator 209 is the key. The keystream generator 203 is seeded from the output of the seed generator 209, as shown in FIG. 12, to generate the second keystream ks₂.

After decryption of t bits from ciphertext C_{b}, the message subset is some or all of these t bits, not necessarily in consecutive order, and these are hashed by the data transformer 207 to produce the hash H₁. The data stream input to the seed generator 209 is now the sum of Hₘ and H₁. The keystream generator 203 is updated with the new seed value as output by the seed generator 209 and the next t bits of ciphertext C_{b} are decrypted using the output second keystream ks₂. The procedure repeats with a new seed value produced by the seed generator 209 after decryption of every t bits, until the whole of the ciphertext C_{b} has been decrypted and the message recovered.

As well as hardware realisations, the various embodiments may be implemented in software running on a computing platform represented schematically in FIG. 13 which may be a well-known type of platform, such as a server, a desktop computer, laptop computer, a tablet computer, a smartphone such as an iOS™ (RTM), Blackberry™ (RTM) or Android™ (RTM) based smartphone, a ‘feature’ phone, a personal digital assistant (PDA), or any processor-powered device with suitable input and display means. Network/Internet communications may comprise a terrestrial cellular network such as a 2G, 3G or 4G network, a private or public wireless network such as a WiFi™ (RTM) based network and/or a mobile satellite network or a wired/fibre communications system. Embodiments of the present invention may be implemented as programmable code for execution by such computer systems. It is well known how to produce software that simulates the actions of circuits such as encryption and decryption devices, hash function devices, modulo p adders and subtractors, permutation devices and general memory devices used to implement the embodiments of the invention. After reading this description, it will become apparent to a person skilled in the art how to implement the invention using computer systems and/or computer architectures.

Alternative embodiments may be implemented as control logic in hardware, firmware, or software or any combination thereof.

### ALTERNATIVES AND MODIFICATIONS

It will be understood that embodiments of the present invention are described herein by way of example only, and that various changes and modifications may be made without departing from the scope of the invention. For example, it should be appreciated that the computing modules of the exemplary embodiments may be combined into a single module or divided into additional modules, and the encryption and decryption systems may include additional components, sub-components, modules, and devices commonly found in a computing system/device, which are not illustrated for clarity of the description.

In embodiments described above, the same cryptography key is used to produce the first keystream ks₁ and the second keystream ks₂. As those skilled in the art will appreciate, different keys may instead be used as respective input to the keystream generator 203 to produce the first keystream ks₁, and to the seed generator 209 to generate the second seed value to produce the second key stream ks₂.

In embodiments described above, the seed generator is configured to compute a seed value indirectly from the plaintext data values, using the transformed data stream output by the data transformer based on the plaintext. As those skilled in the art will appreciate, the seed generator may instead or additionally be configured to generate a seed value based on values directly from the plaintext data.

In embodiments described above, the original plaintext message data itself is passed to the data transformer. Therefore, if an identical message is subsequently enciphered, the two resulting ciphertexts will be identical. As this characteristic can be of value to an eavesdropper, a further possible advantageous modification may be to prepend or append the plaintext message with supplemental data that has a high probability of being unique for the respective message instances, such as a timestamp or a nonce. The recipient does not need to know the supplemental data beforehand in order to decrypt the ciphertext. As yet another alternative, the key itself may be prepended or appended with such supplemental data, but in this case the recipient has to know the timestamp or nonce as well as the key in order to decrypt the ciphertext.

Yet further alternative embodiments may be envisaged, which nevertheless fall within the scope of the following claims.

1. An encryption method of generating ciphertext from a message consisting of a stream of data values, the method comprising:
applying a function to part or all of the message data to generate a function output;
encrypting the function output to form a first part of the ciphertext;
generating a seed value based on the function output and a key;
using the generated seed value to seed a random number generator that outputs a stream of random numbers; and
adding, modulo an integer p, the output stream of the random number generator to the message data stream to produce a second part of the ciphertext.

2. The method of claim 1 wherein the function output is a hash of the message.

3. The method of claim 1 wherein an extendable hash function is used for the random number generator.

4. The method of claim 1 wherein the function output is encrypted with one of a stream cipher or a block cipher, to form the first part of the ciphertext.

5. The method of claim 4, wherein the stream cipher adds, modulo the integer p, a stream of random numbers output by a random number generator that uses said key in seeding the random number generator, to the message data stream to produce the first part of the ciphertext.

6. The method of claim 5 wherein the seed value for the random number generator is formed from the key and at least a portion of the second part of the ciphertext.

7. The method of claim 1 wherein the seed value is generated by combining the key with a hash of the message added to a hash of a subset of the message.

8. The method of claim 1 wherein the seed value is generated by combining the key with a hash of the message summed with a hash of a permuted subset of the message, said permutation being determined by a previous value resulting from the summation.

9. The method of claim 1, further comprising decrypting a ciphertext, the decryption comprising:
decrypting a first part of the ciphertext to reproduce the function output of part or all of the message;
generating a seed value based on the reproduced function output and the key;
using the generated seed value, based on the reproduced function output and the key, to seed a random number generator for decryption; and
subtracting, modulo an integer p, an output stream of the random number generator for decryption, from the second part of the ciphertext to reproduce the message.

10. The method of claim 9 wherein the function output is reproduced by decrypting the first part of the ciphertext with one of a stream cipher for decryption or a block cipher for decryption.

11. The method of claim 9 further comprising verifying the decryption by comparing the decrypted function output of part or all of the message with a calculated function output of part or all of the decrypted message.

12. The method of claim 9 wherein the seed value based on the reproduced function output and the key is generated by combining the key with the decrypted hash of the message added to a hash of a subset of the decrypted message.

13. The method of claim 9 wherein the seed value based on the reproduced function output and the key is generated by combining the key with the decrypted hash of the message summed with a hash of a permuted subset of the decrypted message, said permuted subset being determined by a previous value formed from the summation.

14. A system comprising one or more processors configured to generate a keystream for cipher stream encryption of plaintext data, wherein the keystream is derived by a random number generator using a seed value computed from said plaintext.

15. The system of claim 14, wherein the seed value is computed at least in part from said plaintext.

16. The system of claim 14, wherein the seed value is computed as a combination of a mapping of said plaintext using a predefined mapping function, and an encryption key.

17. The system of claim 16, wherein the predefined mapping function defines a mapping of said plaintext to output data of a fixed size.

18. The system of claim 17, further comprising combining the mapping of said plaintext with a keystream generated from the encryption key as the seed value.

19. A non-transitory computer-readable medium comprising computer-executable instructions, that when executed, perform an encryption method of generating ciphertext from a message consisting of a stream of data values, by:
applying a function to part or all of the message data to generate a function output;
encrypting the function output to form a first part of the ciphertext;
generating a seed value based on the function output and a key;
using the generated seed value to seed a random number generator that outputs a stream of random numbers; and
adding, modulo an integer p, the output stream of the random number generator to the message data stream to produce a second part of the ciphertext.

20. The non-transitory computer-readable medium of claim 19, further comprising computer-executable instructions, that when executed, perform decryption of a ciphertext by:
decrypting a first part of the ciphertext to reproduce the function output of part or all of the message;
generating a seed value for decryption based on the reproduced function output and a key;
using the generated seed value for decryption, to seed a random number generator for decryption that outputs a stream of random numbers for decryption; and
subtracting, modulo an integer p, the output stream of the random number generator for decryption from the second part of the ciphertext to reproduce the message.
